(19) United States
(12) Patent Application Publication
(10) Pub. No.: US 2006/0196888 A1
(43) Pub. Date: Sep. 7, 2006

(54) Glue gun assembly with temperature indicator and drip reducing base

(76) Inventors: Michael L. Agronin, Owings Mills, MD (US); Daniele C. Brotto, Baltimore, MD (US); Daniel Bone, Langley Moor (GB); James D. Marshall, Mallorytown (CA); Joe Rogers, Jarrettsville, MD (US); Christopher J. Murray, Baltimore, MD (US)

Correspondence Address: HARNESS, DICKEY & PIERCE, P.L.C., P.O. BOX 828, BLOOMFIELD HILLS, MI, 48303, US

(21) Appl. No.: 11/297,813

(22) Filed: Dec. 8, 2005

Related U.S. Application Data
(60) Provisional application No. 60/637,354, filed on Dec. 17, 2004.

(51) Int. Cl. B67D 5/62

(52) U.S. Cl. 222/146.5; 222/173; 222/179.5; 222/23

(57) ABSTRACT

A glue gun assembly has a base and a glue gun for application of an adhesive. The glue gun is removably supported by the base. The glue gun has a heating apparatus that can be heated to heat adhesive which flows out of the glue gun. The glue gun also has a temperature indicator that is movable, between positions, depending on the temperature of the heating apparatus. This indicates the temperature of the heating apparatus to the user. The base includes a support member that positions the glue gun such that an exit end of the glue gun is disposed higher than a receiving end of the glue gun. Accordingly, this reduces dripping of glue from the exit end of the glue gun.

### CROSS REFERENCE TO RELATED APPLICATION

This application claims the benefit of U.S. Provisional Application No. 60/637,354, filed Dec. 17, 2004.

### FIELD OF THE DISCLOSURE

The present invention relates to glue guns and, more particularly, to a glue gun assembly which includes a temperature indicator and a drip reducing base.

### BACKGROUND OF THE DISCLOSURE

Hot melt glue guns are used in a variety of ways and generally when making crafts. Glue guns are usually plugged into a wall socket to heat a heating element or barrel within the glue gun housing. Once the barrel is sufficiently hot, a glue stick, loaded in the barrel, melts and flows out of the glue gun for use.

Glue guns do not ordinarily provide feedback as to whether or not the glue gun is hot enough for use. Typically, users become aware that the glue gun is ready for use when glue begins dripping out of the barrel tip. Likewise, many glue guns retain heat for a significant amount of time, but the glue gun does not indicate when the tip is cool enough to touch or replace.

Furthermore, glue guns can be messy to use and clean. For example, glue can inadvertently drip from the glue gun, especially when the glue gun is not in use.

Therefore, there remains a need for a glue gun that readily indicates the temperature of the heating element to the user. There also remains a need for a glue gun that is less likely to inadvertently drip glue.

### SUMMARY OF THE DISCLOSURE

The present invention is a glue gun for application of an adhesive that includes a heating apparatus to heat the adhesive to thereby enable the adhesive to flow out of the glue gun. The glue gun also includes a temperature indicator that is movable between positions depending on the temperature of the heating apparatus. This indicates the temperature of the heating apparatus to the user.

In another aspect, the present invention provides a base to support a glue gun. The base includes a support member that can support the glue gun such that an adhesive exit end of the glue gun is disposed higher than an adhesive receiving end of the heating element. As such, dripping of glue from the exit end of the glue gun is reduced when the support member supports the glue gun.

In still another aspect, the present invention is a glue gun assembly that includes a base and a glue gun for application of an adhesive. The glue gun is adapted to be removably supported by the base. The glue gun includes a heating apparatus that can be heated to enable the adhesive to flow out of the glue gun. The glue gun also includes a temperature indicator that is movable between positions depending on the temperature of the heating apparatus. Accordingly, this indicates the temperature of the heating apparatus to the user.

From the following detailed description, other objects and advantages of the present invention will become apparent to those skilled in the art.

### BRIEF DESCRIPTION OF THE DRAWINGS

The present invention will become more fully understood from the detailed description and the accompanying drawings, wherein:

FIG. 1 is a perspective view of a glue gun and its base in accordance with the present invention;

FIG. 2 is a perspective view of the glue gun supported by the base in accordance with the present invention;

FIG. 3 is a perspective view of the base in accordance with the present invention;

FIG. 4 is an elevation view of a glue gun in accordance with the present invention;

FIG. 5 is a cross-sectional view of the glue gun of FIG. 4;

FIG. 5A is a perspective view partially in section of the temperature indicator;

FIG. 6 is an elevation view of the glue gun tip with the temperature indicator in a first position; and

FIG. 7 is an elevation view of the glue gun tip with the temperature indicator in a second position.

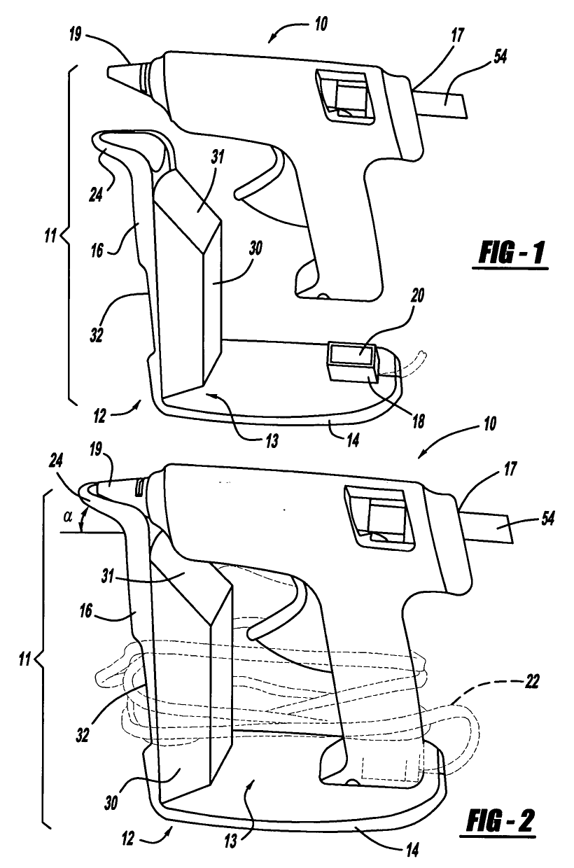

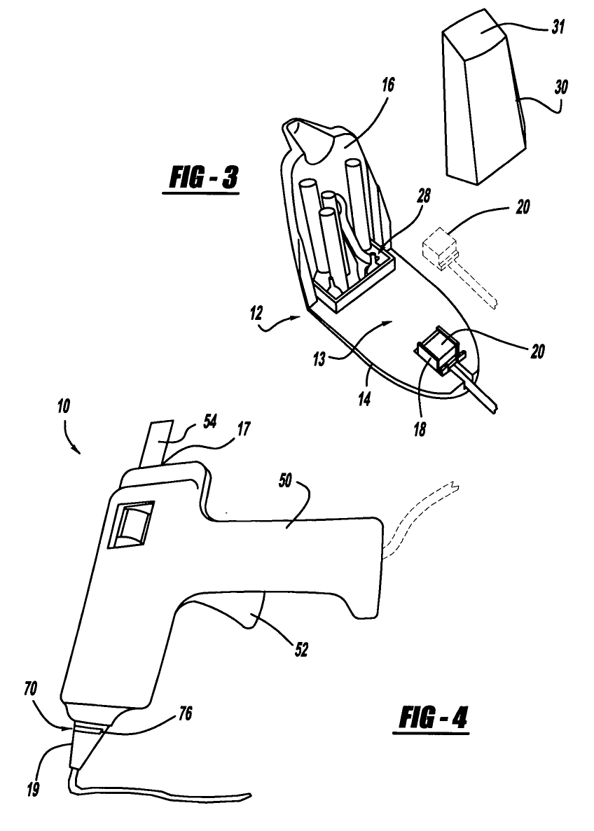

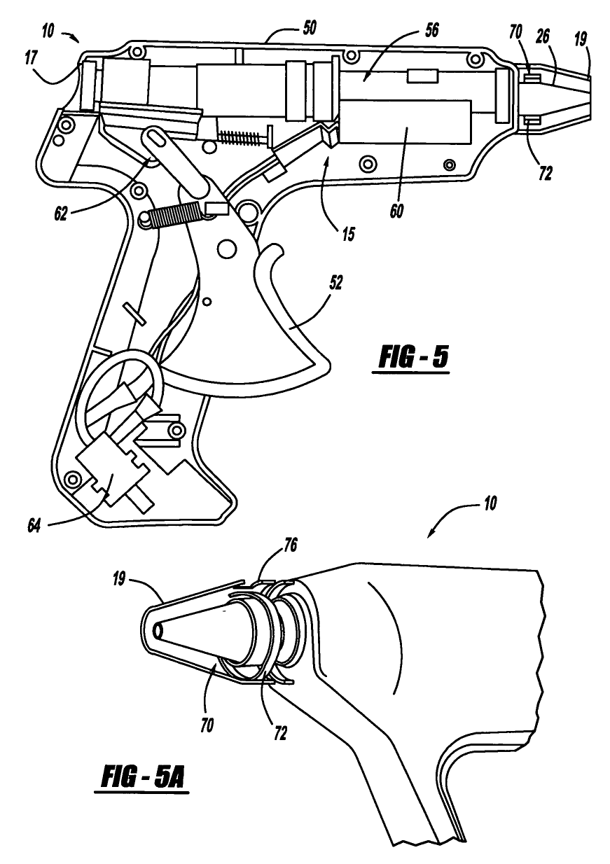

### DETAILED DESCRIPTION OF THE PREFERRED EMBODIMENTS

Referring to the figures, a glue gun assembly 11 constructed according to the present invention is illustrated. The glue gun assembly 11 includes a glue gun, generally indicated at 10, and a base, generally indicated at 12.

The glue gun 10 includes a clamshell housing 50 in one embodiment. The housing 50 defines a receiving end 17 that enables the glue gun 10 to receive an adhesive, such as a glue stick 54. The glue gun 10 further includes a heating apparatus 15 (FIG. 5) within the housing 50. Generally, the heating apparatus 15 can be heated to melt the glue stick 54 at least partially and enable the melted adhesive to flow out of the glue gun 10 for use.

In the embodiment shown in FIG. 5, the heating apparatus 15 includes a heating element 60 with a relatively high electrical resistance. The heating apparatus 15 also includes a heating barrel 56, which is coupled to the heating element 60 and which receives the glue stick 54. The heating element 60 is also coupled with an electrical connector 64. The glue gun 10 also includes a trigger 52, which projects from the housing 50. The trigger 52 is coupled with a linkage 62 such that the glue stick 54 advances further into the barrel 56 when the trigger 52 is actuated.

Accordingly, the electrical connector 64 delivers electricity to the heating element 60, which converts the electricity to heat. This heat is transferred to the barrel 56 to melt at least a portion of the glue stick 54. The trigger 52 is actuated to advance the glue stick 54 further into the barrel 56 to further melt the glue stick 54. The melted adhesive flows out of the end of the nozzle housing 19 of the glue gun 10 for use.

In the embodiment shown, a nozzle 26 is included inside the nozzle housing 19 of the glue gun 10. The nozzle 26 is coupled to the barrel 56 and is funnel-shaped. As such, the nozzle 26 limits the flow of adhesive to a thin, useful sized bead.

The glue gun 10 is adapted to be removably supported by the base 12. In the embodiment shown, the base 12 includes a support member 13 that is generally L-shaped with a horizontal leg 14 and a vertical leg 16. The horizontal leg 14 includes a retention member 18 which retains a socket 20 of a power cord 22. The electrical connector 64 of the glue gun 10 is able to electrically connect to the socket 20 of the power cord 22 to supply power to the heating element 60. The socket 20 is removable from the retention member 18 of the base 12. Accordingly, if the user desires, the socket 20 may be removed from the base 12 while remaining connected to the electrical connector 64 of the glue gun 10. Alternatively, if the user desires, the electrical connector 64 can be disconnected from the socket 20 of the power cord 22 for cordless use of the glue gun 10.

The vertical leg 16 of the base 12 includes a protective shroud 24. In one embodiment, the shroud 24 has a semi-conical shape which receives the nozzle housing 19 of the glue gun 10. The shroud 24 at least partially covers the nozzle cover 19 and protects a user from inadvertently touching it.

Also, the base 12 includes a storage compartment 28. The storage compartment 28 is defined by a cover 30 which is removably coupled to the base 12. In one embodiment, the cover 30 is snap fit or friction fit onto the vertical leg 16 of the base 12. Also, the base 12 has an angled top side 31 to provide clearance for the glue gun 10 when the glue gun 10 is supported by the base 12. The storage compartment 28 may be utilized to store extra nozzles 26, glue sticks 54, or tools such as wrenches to be utilized with the glue gun 10.

Also, the base 12 includes a cut out portion 32. In the embodiment shown, the cut out portion 32 is included on the vertical leg 16. The cut out portion 32 can receive the power cord 22 to enable the power cord 22 to be compactly wrapped around the glue gun 10 and the base 12 as seen in FIG. 2. Once the cord 22 is wrapped around the gun and base, the gun is secured in position for convenient storage.

Furthermore, the configuration of the vertical leg 16 and the shroud 24 causes the glue gun 10 to be supported by the base 12 with the nozzle housing 19 of the glue gun 10 disposed higher than the receiving end 17 of the glue gun 10. More specifically, the shroud 24 is positioned at an angle α, for instance between 5° to 15°, with respect to horizontal. This angle α ensures that the nozzle 26 is pointed upward. Accordingly, due to the position of the glue gun 10 on the base 12, there is less dripping of glue from the nozzle 26.

In addition, the glue gun 10 includes a temperature indicator 70 as shown in FIGS. 5, 5A, 6, and 7. The temperature indicator 70 is movable between positions depending on the temperature of the heating apparatus. For instance, in one embodiment, the temperature indicator 70 includes a bi-metal or thermostat metal coil strip 72 made from at least two strips bonded or otherwise secured to one another. More specifically, the temperature indicator 70 is manufactured from a bi-metal material which includes two strips of alloys with different coefficients of thermal expansion that are bonded into a single sheet. In another embodiment, a strip of one material is coated with another material having a different coefficient of thermal expansion. It should be understood that the temperature indicator 70 could be made in any suitable manner. In one embodiment, the bi-metal strip is a B1 bi-metal with a thickness of about 0.007″ and is 5″ long.

The temperature indicator 70 is at least partially coiled about the barrel 56. The temperature indicator 70 is coupled at one end to the barrel 56 by mechanical means, welding, spring clip fasteners, or other coupling techniques to provide good thermal conductivity. As such, when the barrel 56 is heated, the temperature indicator 70 receives heat from the barrel 56. As the temperature indicator 70 heats, the temperature indicator 70 moves by either coiling (tighter) or uncoiling (looser) depending on how the strip 72 is wound (i.e., depending on which of the pluralities of materials is disposed on the outer surface of the temperature indicator 70). Then, when the heating barrel 56 cools, the temperature indicator 70 also cools and moves in the opposite manner. In another embodiment, the temperature indicator 70 is axially straight when cool, but as the temperature indicator 70 heats up, the temperature indicator 70 bends and partially coils. Thus, by coiling and uncoiling, the temperature indicator 70 indicates the temperature of the heating barrel 56 which indicates to the user when the heat gun 10 is hot enough for use.

In one embodiment, the heating apparatus 15 reaches a temperature of about 200° F. to begin melting the glue stick 54. Heating from room temperature to about 200° F. causes the temperature indicator 70 to rotate about 45°. It should be appreciated that the temperature indicator 70 bends more over a given temperature range if made out of thinner, rather than thicker, bi-metal materials. Also, it should be appreciated that the temperature indicator 70 bends more if it is longer and bends less if it is shorter. Furthermore, the temperature indicator 70 may be wound with the higher thermal coefficient material on the outside of the coil which causes it to wind tighter as the temperature increases. Alternatively, the temperature indicator 70 may be wound with the higher thermal coefficient material on the inside of the coil causing the temperature indicator 70 to uncoil as the temperature increases.

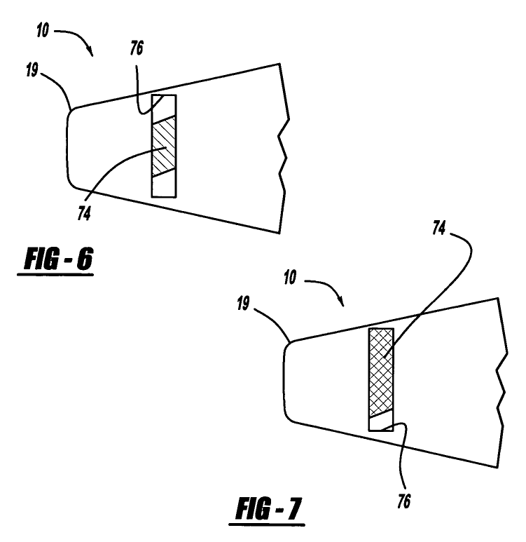

In the embodiment shown in FIGS. 6 and 7, the temperature indicator 70 includes a visual indicator 74, such as a graphic or label. This provides visual indication of the temperature of the heating apparatus 15 (i.e., the temperature of the barrel 56 and/or the nozzle 26) to the user.

In one embodiment, the visual indicator 74 includes a plurality of portions that differ by color to distinguish between a plurality of temperatures of the heating apparatus 15. Also, the housing 50 includes a window 76 which reveals a portion of the temperature indicator 70 and the visual indicator 74 to the user. As the temperature indicator 70 moves, different portions of the visual indicator 74 are revealed through the window 76 indicating whether the glue gun 10 is hot or cool.

For example, the visual indicator 74 may have a blue portion (FIG. 6) and a red portion (FIG. 7) to indicate the temperature of the barrel 56 and/or the nozzle 26. The portions of the visual indicator 70 are disposed relative to the temperature indicator 70 such that the blue portion shows through the window 76 when the heating apparatus 15 is cool (e.g., less than 110° F. or cool enough to touch) and such that the red portion shows through the window 76 when the heating apparatus 15 is hot (e.g. above 200° F. or hot enough to melt the glue stick 54).

It should be appreciated that the visual indicator 74 could be of any suitable type. For instance, in an alternate embodiment, a temperature scale is placed on the housing 50 adjacent the window 76 and the visual indicator 74 has a marker thereon. As the temperature indicator 70 moves, the marker moves relative to the scale to indicate the temperature of the heating apparatus 15. The visual indicator 74 could also include numbers, words such as “Hot” and “Cold”, or other representative symbols. The visual indicator 74 can include elements on one of or both of the housing 50 and the temperature indicator 70.

While the above provides a detailed description of the preferred embodiment, those skilled in the art will understand that alterations, variations and modifications can be made without deviating from the scope of the disclosure.

1. A glue gun for application of an adhesive, the glue gun comprising:
a heating apparatus for melting adhesive to flow out of the glue gun; and
a temperature indicator that is movable between positions depending on the temperature of the heating apparatus to indicate the temperature of the heating apparatus to the user.

2. The glue gun of claim 1, wherein the temperature indicator is at least partially coiled, and wherein the temperature indicator moves between positions by coiling and uncoiling.

3. The glue gun of claim 1, wherein the temperature indicator is made from a plurality of materials, and wherein at least two of the plurality of materials have different coefficients of thermal expansion to provide temperature-dependent movement of the temperature indicator.

4. The glue gun of claim 1, wherein the temperature indicator is coupled to the heating apparatus.

5. The glue gun of claim 1, wherein the temperature indicator is at least partially coiled about the heating apparatus.

6. The glue gun of claim 1, further comprising a housing that at least partially encapsulates the temperature indicator, the housing including a window adapted to reveal the temperature indicator to the user.

7. The glue gun of claim 1, further comprising at least one visual indicator adapted to provide visual indication of the temperature of the heating apparatus to the user.

8. The glue gun of claim 7, wherein the at least one visual indicator includes a plurality of portions that differ by color to distinguish between a plurality of temperatures of the heating apparatus.

9. A base for supporting a glue gun comprising:
a support member that can support the glue gun such that an exit end of the glue gun is disposed higher than a receiving end of the glue gun, thereby reducing dripping of glue from the exit end of the glue gun when the support member supports the glue gun.

10. The base of claim 9, further comprising a protective shroud that at least partially covers the exit end of the glue gun when the support member supports the glue gun.

11. The base of claim 9, further comprising a power cord that is removably coupled to the support member.

12. The base of claim 9, further comprising at least one of a storage compartment and a cut out portion for receiving a power cord.

13. A glue gun assembly comprising:
a base; and
a glue gun for application of an adhesive, the glue gun adapted to be removably supported by the base, the glue gun also comprising a heating apparatus for melting adhesive to flow out of the glue gun, and a temperature indicator that is movable between positions depending on the temperature of the heating apparatus to indicate the temperature of the heating apparatus to the user.

14. The glue gun assembly of claim 13, wherein the base comprises a support member that can support the glue gun such that an exit end of the glue gun is disposed higher than a receiving end of the glue gun, thereby reducing dripping of glue from the exit end when the support member supports the glue gun.

15. The glue gun assembly of claim 13, wherein the base includes a power cord for supplying power to the heating apparatus, the power cord removably coupled to the base.

16. The glue gun assembly of claim 15, wherein the glue gun includes an electrical connector that can electrically connect to the power cord.

17. The glue gun assembly of claim 13, wherein the temperature indicator of the glue gun is at least partially coiled, and wherein the temperature indicator moves between positions by coiling and uncoiling.

18. The glue gun assembly of claim 13, further comprising at least one visual indicator adapted to provide visual indication of the temperature of the heating apparatus to the user.

19. A temperature indicator for a tool comprising:
a tool;
and a temperature indicator having two or more materials having different coefficients of thermal expansion, the temperature indicator being attached to a heating apparatus such that the temperature indicator coils or uncoils with a change in temperature of the heated element.

20. The temperature indicator of claim 19 wherein the temperature indicator includes at least one visual indicator to provide the temperature of the heating apparatus.

21. The temperature indicator of claim 20, wherein the visual indicator is one or more colored portions on the temperature indicator, the colored portions being adapted to be seen through a window in the tool to indicate the temperature of the heating apparatus.
